(19) United States
(12) Patent Application Publication
(10) Pub. No.: US 2006/0045678 A1
(43) Pub. Date: Mar. 2, 2006

(54) Hydraulic vehicle restraint providing horizontal and vertical spring float with a mechanical hard travel limit

(76) Inventor: Jonathan Andersen, Grafton, WI (US)

Correspondence Address: HANLEY, FLIGHT & ZIMMERMAN, LLC, 20 N. WACKER DRIVE, SUITE 4220, CHICAGO, IL, 60606, US

(21) Appl. No.: 10/915,838

(22) Filed: Aug. 11, 2004

(51) Int. Cl. B65G 67/00

(52) U.S. Cl. 414/401

(57) ABSTRACT

A vehicle restraint for a loading dock employs spring force to urge the restraint's barrier up and back against a truck's rear ICC bar, whereby the spring loaded barrier accommodates both horizontal and vertical float of the bar as the truck is loaded or unloaded of its cargo. While spring force urges the barrier up and back, hydraulic force can move the barrier selectively down and forward. The restraint includes a positive mechanical stop that limits the distance that the truck can move away from the face of the dock. The restraint is particularly suited for mounting within a pit underneath a dock leveler.

### BACKGROUND OF THE INVENTION

1. Field of the Invention

The subject invention generally pertains to a vehicle restraint that engages a truck's rear ICC bar to help prevent the truck from accidentally pulling away from a loading dock and more specifically pertains to a pit-mounted vehicle restraint that includes hydraulic extension, spring return, and a positive mechanical stop that limits the vehicle restraint's extension.

2. Description of Related Art

When loading or unloading a truck parked at a loading dock, it is generally a safe practice to help restrain the truck from accidentally moving too far away from the dock. This is typically accomplished by a hook-style vehicle restraint that engages what is often referred to in the industry as an ICC bar or a Rear Impact Guard (RIG). An ICC bar or RIG is a bar or beam that extends horizontally across the rear of a truck, below the truck bed. Its primary purpose is to help prevent an automobile from under-riding the truck in a rear-end collision.

An ICC bar, however, also provides a convenient structure for a hook-style restraint to reach up in front of the bar to obstruct the bar's movement away from the dock. A typical example of such a vehicle restraint is disclosed in U.S. Patent Application Publication 2004/0042882. The restraint described in that application extends and retracts hydraulically to firmly capture an ICC bar within a hook. Hydraulic pressure of the hook cylinder resists any longitudinal movement of the hook. Using hydraulics to arrest the horizontal movement of an ICC bar, however, may create a couple of problems.

First, a hook-restrained truck (i.e., the hook is hydraulically moved and held in contact with the ICC bar) forcibly pulling away from a dock can pull on the hook with several tons of force. If it is the hydraulic pressure in the hook's cylinder that arrests the pulling force of the truck, extreme pressure may develop within the cylinder (pulling force of the truck divided by the effective area of the piston). This is particularly true when the pressure is at the rod end of the cylinder, as the cross-sectional area of the piston rod reduces the effective area of the piston. Moreover, when the pressure is at the rod end, highly pressurized hydraulic fluid may not only force itself past the piston seal but may also blow past the rod seal.

Secondly, although some vehicle restraints yield in response to incidental vertical movement of a truck's ICC bar, often vehicle restraints do not accommodate horizontal movement of the bar. A vehicle restraint unyielding to at least some horizontal movement can be a problem particularly with trucks whose trailers have pneumatic suspension. As the trailer is being loaded or unloaded of its cargo, the trailer's suspension may allow the trailer bed to rise and descend in response to the change in weight carried by the trailer. With an active pneumatic suspension, the vertical movement may be several inches and is typically accompanied by an equivalent horizontal movement (also known as trailer walk) due to the mechanism of today's pneumatic suspension systems.

In some cases, a truck driver may deactivate the trailer's pneumatic suspension at the loading dock, whereby the trailer descends to a lowered position so that the trailer bed stays at a generally constant, bottomed-out elevation as the trailer is being loaded or unloaded. If the vehicle restraint engages the ICC bar prior to deactivating the pneumatic suspension, the tremendous weight of the rear end of the trailer plus about half its cargo weight (e.g., 34,000 pounds in all) suddenly forces itself down upon the hook, thus attempting to push the hook downward and forward several inches. Attempting to hydraulically arrest such movement may damage the ICC bar and blow the seals of the restraint's hydraulic cylinder and/or cause damage to other hydraulic components.

### SUMMARY OF THE INVENTION

In some embodiments, a vehicle restraint employs spring force to urge the restraint's barrier up and back against a vehicle's ICC bar, whereby the spring force accommodates both horizontal and vertical float of the bar.

In some embodiments, spring force moves the barrier up and back, and hydraulic force moves the barrier down and forward.

In some embodiments, the vehicle restraint employs the combined effort from both a hydraulic system and a spring system to move the barrier to a stored position.

In some embodiments, the vehicle restraint employs the combined effort from both a hydraulic system and a spring system to move the barrier to an operative position.

In some embodiments, the vehicle restraint relies on a hydraulic cylinder's mechanical travel limit, rather than its hydraulic pressure, to limit the extent to which the vehicle's ICC bar can move away from the front face of a loading dock.

In some embodiments, the return spring of a hydraulic cylinder is mounted outside of the cylinder to reduce the overall length of the cylinder/spring assembly and to achieve a greater spring force than what could otherwise be achieved by mounting a smaller spring within the cylinder.

In some embodiments, a hydraulic cylinder of the vehicle restraint is operated as a single-acting cylinder so that the hydraulic power system only affects the forward movement of the barrier until the cylinder reaches its mechanical travel limit.

In some embodiments, a hydraulic cylinder of the vehicle restraint is operated as a single-acting cylinder so that the hydraulic power system only affects the downward movement of the barrier until the barrier or the cylinder bottoms out.

In some embodiments, the barrier of the vehicle restraint stores underneath a dock leveler.

In some embodiments, the vehicle restraint is powered by the hydraulic system of the dock leveler.

In some embodiments, the barrier of a vehicle restraint can not only rotate vertically to engage or disengage a vehicle's ICC bar, but the barrier can also rotate horizontally to minimize the overall length of the restraint when in its stored position, whereby the restraint may be more readily stored underneath a dock leveler.

### BRIEF DESCRIPTION OF THE DRAWINGS

FIG. 1 is a perspective view of a vehicle restraint.

FIG. 2 is a perspective view of the vehicle restraint of FIG. 1 installed in a sub-pit underneath a dock leveler.

FIG. 3 is a schematic side view showing the restraint in a stored position.

FIG. 4 is a schematic side view showing the restraint in a lowered, fully extended position.

FIG. 5 is a schematic side view showing the restraint in a raised, fully extended position.

FIG. 6 is a schematic side view showing the restraint within its range of resilient operative positions.

FIG. 7 is a schematic side view showing the restraint raised and fully extended to its mechanically limited position.

FIG. 8 is a perspective view of the restraint in a shipping box.

FIG. 9 is a top view of a barrier/cylinder mechanism in a retracted position.

FIG. 10 is a side view of the mechanism of FIG. 9.

FIG. 11 is a top view of the mechanism of FIG. 9 but with the barrier fully extended.

FIG. 12 is a side view of the mechanism of FIG. 11.

### DESCRIPTION OF THE PREFERRED EMBODIMENT

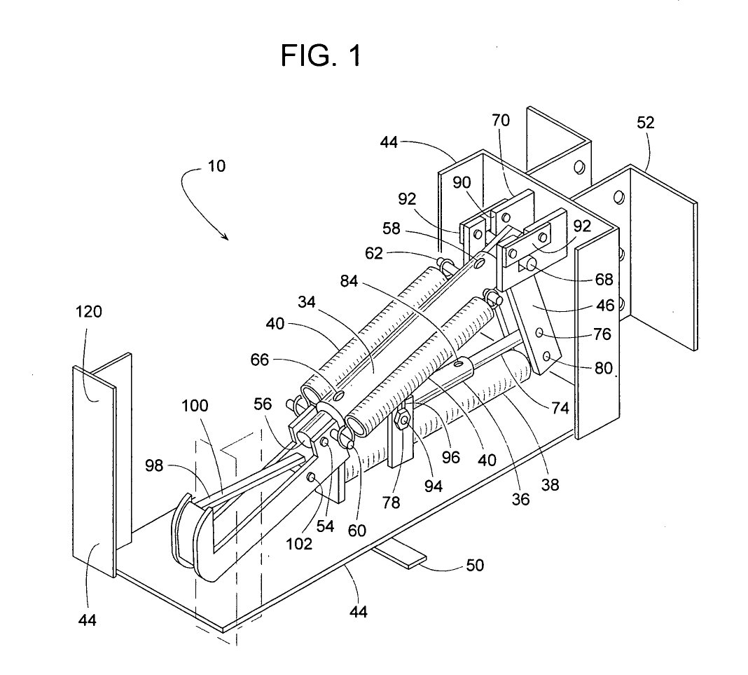

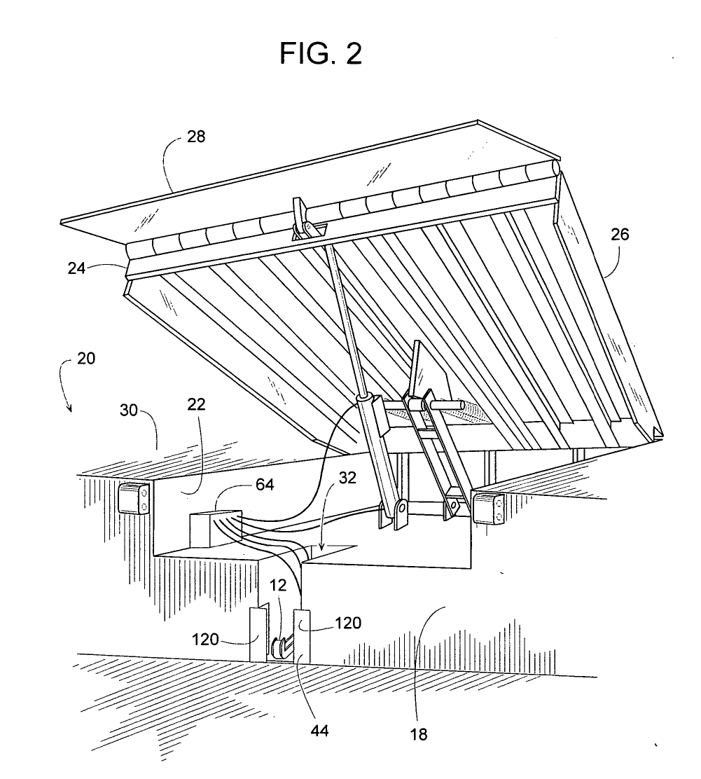

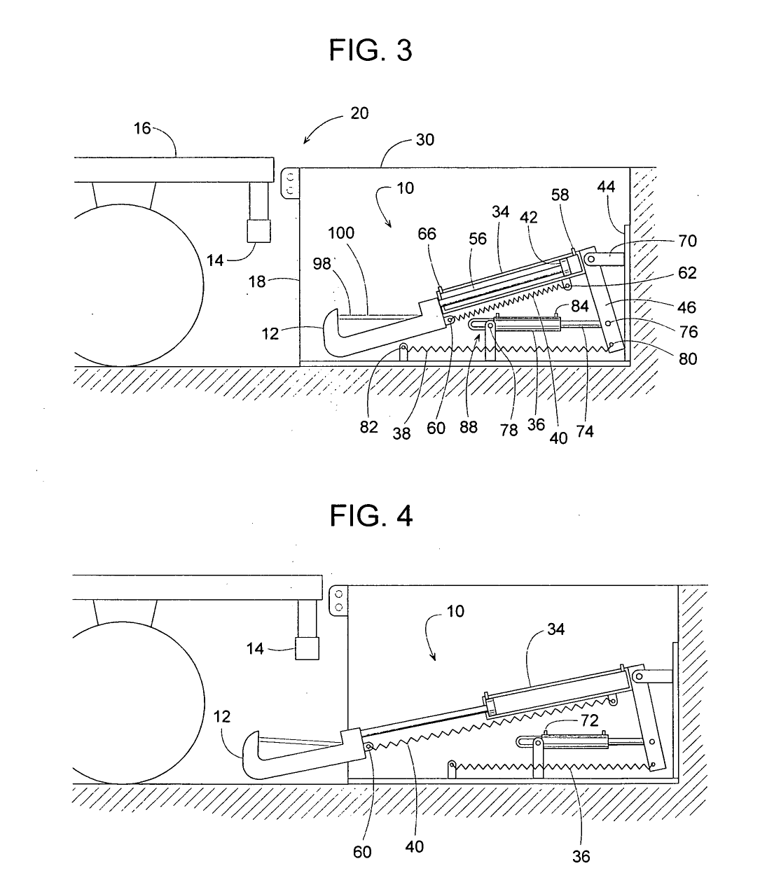

A vehicle restraint 10 includes a barrier 12 for engaging an ICC bar 14 of a truck 16 to help prevent the truck from accidentally pulling forward and away from a face 18 of a loading dock 20 as the truck is being loaded or unloaded of its cargo. To facilitate the loading and unloading operations, dock 20 may have a pit 22 that contains a conventional dock leveler 24. Dock leveler 24 includes a pivotal deck 26 and a lip 28 for providing a bridge between a dock platform 30 and a rear edge of truck 16. In this particular example, dock leveler 24 happens to be hydraulically actuated; however, vehicle restraint 10 can be used with other types of dock levelers, or it can be used alone without any dock leveler. FIG. 1 shows restraint 10 alone, FIG. 2 shows the restraint installed in a sub-pit 32 underneath dock leveler 24, and FIGS. 3-7 schematically illustrate restraint 10 in its various operating positions.

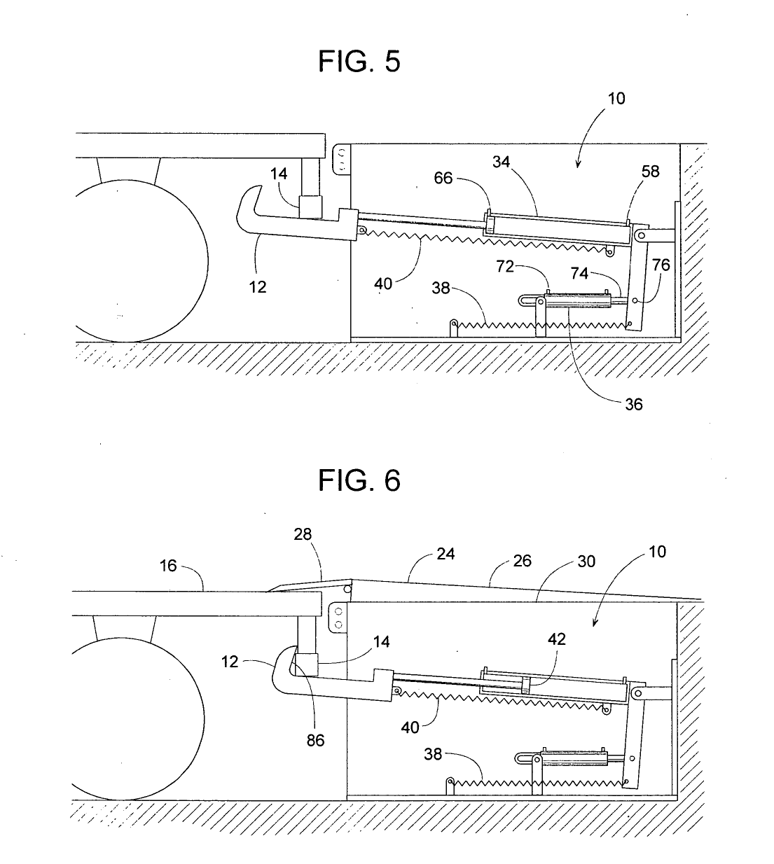

In typical operation, truck 16 backs into dock 20 while vehicle restraint 10 is in its stored position, wherein barrier 12 is retracted and lowered as shown in FIG. 3. Next, a barrier actuator, preferably in the form of a main cylinder 34 (preferably but not necessarily hydraulic) extends barrier 12 to reach underneath ICC bar 14, as shown in FIG. 4. While barrier 12 is fully extended, a positioning actuator, preferably in the form of a position cylinder 36 (preferably but not necessarily hydraulic) releases its fluid pressure to allow the tension in one or more position springs 38 to raise barrier 12 up against the underside of bar 14 to an operative position, as shown in FIG. 5. Once barrier 12 engages bar 14 at an operative position, main cylinder 34 can release its hydraulic pressure to enable the tension in one or more retract springs 40 to draw barrier 12 back against a front edge of bar 14 to a retracted operative position. The retracted operative position is beneficial in that barrier 12 is pulled into contact with bar 14 meaning that any movement of bar 14 away from the dock face will be inhibited by the presence of barrier 12. Compare the position of barrier 12 in the retracted operative position of FIG. 6 to the operative position of FIG. 5 in which movement of bar 14 away from the dock face would initially be unimpeded by barrier 12 because of the separation between the two. The current design thus has the advantage of automatically retracting barrier 12 to the retracted operative position—to inhibit any movement of bar 14 away from the dock face at this point in the operational sequence, dock leveler 24 can position its deck 26 and lip 28 as shown in FIG. 6.

With the barrier 12 in the retracted operative position, springs 38 and 40 provide barrier 12 with a range of resilient operative positions where barrier 12 remains in snug contact with bar 14. The term, “spring,” broadly encompasses any device that can store energy for providing a resilient or restorative force. Examples of a spring include, but are not limited to, a coiled tension spring, a coiled compression spring, leaf spring, gas spring (e.g., pneumatic cylinder or bladder), counterweight, rubber or polyurethane cylinder, etc.

To prevent undue strain of the ICC bar structure during its incidental movement, upward spring force 85 and rearward spring force 87 are used to maintain barrier 12 in contact with the ICC bar, as shown in FIG. 6. Spring forces 85 and 87 enable barrier 12 to responsively float, both vertically and horizontally, within a certain range of allowable movement to follow the incidental movement of bar 14 as truck 16 is loaded and unloaded of its cargo. Forces 85 and 87, however, are yieldable; meaning that barrier 12 will yield for substantial applied forces rather than remaining rigid and potentially damaging the ICC bar/RIG.

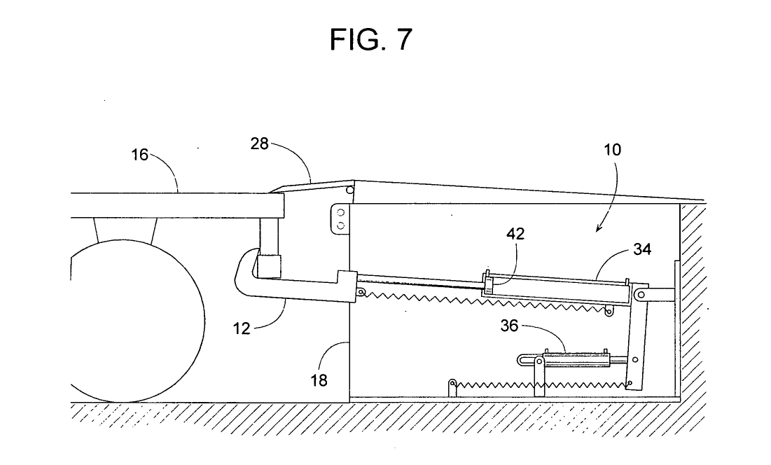

If truck 16 attempts to pull forward away from dock face 18, barrier 12 could follow that motion up to a mechanically limited position, as shown in FIG. 7. In this example, the mechanically limited position is provided by a piston 42 reaching the end of its travel within cylinder 34; however, other mechanical stops could provide such a mechanically limited position. The mechanically limited position should be such that the ICC bar's forward movement is arrested at a position where lip 28 still safely overlaps the rear edge of truck 16.

To release the truck, the piston side of cylinders 34 and 36 are pressurized to extend and lower barrier 12 to the position of FIG. 4. Subsequently, main cylinder 34 is depressurized to allow spring 40 to retract barrier 12 to its stored position of FIGS. 1 and 3.

Although the aforementioned operation can conceivably be achieved by a broad range of mechanisms, in a currently preferred embodiment, vehicle restraint 10 comprises the basic elements of a frame 44, barrier 12, a powered system (e.g., main cylinder 34 and position cylinder 36), a spring system (e.g., position spring 38 and retract spring 40), and a lever arm 46. The term, “powered system” refers to any apparatus that receives energy and converts it to work.

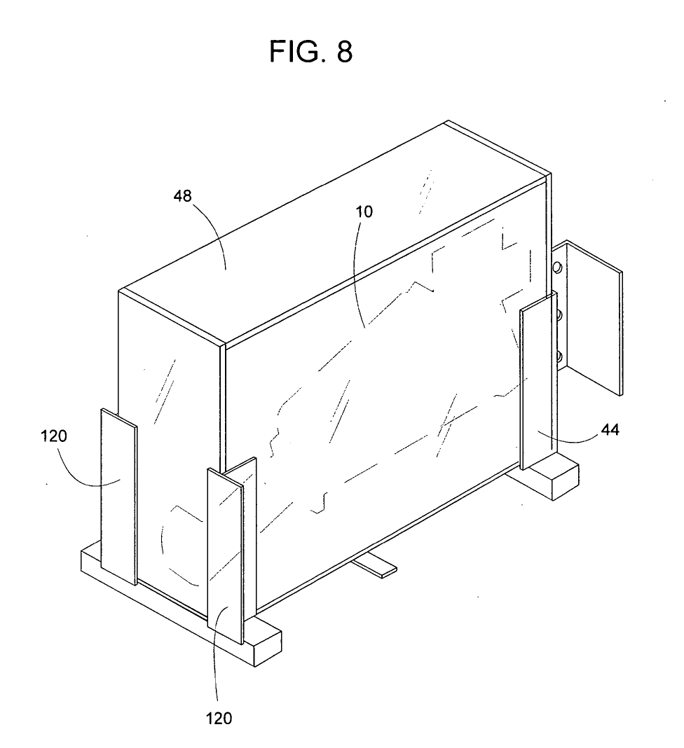

Frame 44 provides a foundation and an anchor for installing restraint 10 within sub-pit 32. Referring to FIG. 8, restraint 10 may initially be housed within a shipping box 48 that also serves as a mold about which concrete can be poured to create sub-pit 32. Once the concrete sets, the walls of box 48 can be broken away and removed, while tabs 50 and 52 remain embedded within the concrete to help anchor frame 44 within sub-pit 32.

To render barrier 12 horizontally movable, one or more fasteners 54 rigidly attach barrier 12 to an extendable piston rod 56 of main cylinder 34. Pressurizing the piston side of cylinder 34 via a first main port 58 extends rod 56 and barrier 12. To retract barrier 12, port 58 is de-pressurized, so spring 40 can draw piston rod 56 back into cylinder 34. The spring return action can be achieved by stretching spring 40 between one anchor point 60 coupled to barrier 12 and another, more stationary, anchor point 62 attached to cylinder 34 or some other suitable location.

Selectively pressurizing and depressurizing port 58 can be achieved with a conventional hydraulic power supply 64 (FIG. 2) with appropriate control valves. Such hydraulic power supplies are well known to those of ordinary skill in the art. In some cases, hydraulic supply 64 is the same supply that serves dock leveler 24, whereby vehicle restraint 10 and dock leveler 24 share the same hydraulic power supply 64. While port 58 is selectively pressurized and depressurized, the rod side of cylinder 34 can be left depressurized by venting a port 66 to a tank of hydraulic power supply 64 or venting it to atmosphere through a suitable breather.

Vertical movement of barrier 12 is achieved by having a pin 68 (e.g., a bolt) pivotally couple main cylinder 34 to a bracket assembly 70 affixed to frame 44. Lever arm 46 is rigidly attached to the base of main cylinder 34 so that position cylinder 36 and position spring 38 can act upon lever arm 46 to rotate main cylinder 34 about pin 68, whereby cylinder 34 pivots to selectively raise and lower barrier 12.

To lower barrier 12, a port 72 on the rod side of cylinder 36 is pressurized to extend the cylinder's piston rod 74. Cylinder 36 is mounted between one point 76 on lever arm 46 and another point 78 coupled to frame 44. So, as cylinder 36 extends, it pushes on lever arm 46 to rotate main cylinder 34 counterclockwise (as viewed from the perspective of FIGS. 3-7), which lowers barrier 12.

To raise barrier 12, port 72 is de-pressurized, so spring 38 can draw piston rod 74 back into cylinder 36, which rotates lever arm 46 and main cylinder 34 clockwise. The spring return action can be achieved by stretching spring 38 between one point 80 on lever arm 46 and another point 82 at a generally fixed location. While hydraulic power supply 64 (with its appropriate control valves) selectively pressurizes and depressurizes port 72 to respectively lower and raise barrier 12, the rod side of cylinder 36 can be left depressurized by venting a rod-side port 84 of cylinder 36 to the tank of supply 64 or venting it to atmosphere through a suitable breather. Even though cylinders 34 and 36 are shown with rod side ports 66 and 84, they can be readily interchanged with ram style (or direct acting) cylinders that only have pressure ports 58 and 72.

Consequently, moving barrier 12 from its stored position where barrier 12 is down and back (FIG. 3) to an operative position where barrier 12 is up and forward (FIG. 5), involves the combined effort (sequentially or simultaneously) of electrically powering barrier 12 forward and spring 38 moving barrier 12 upward via spring force 85. Subsequently, spring force 87 moves barrier 12 to a retracted operative position against bar 14 (FIG. 6). The term, “electrically powering,” refers to any method or mechanism driven by or involving electricity. Electrically powering, for example, may include hydraulic system 64 whose hydraulic pump is driven by an electric motor. It should be noted that spring force 85 is also the force that enables barrier 12 to follow the incidental vertical movement of ICC bar 14 as vehicle 16 is being serviced.

After loading or unloading vehicle 16, moving barrier 12 from its operative position to its stored position involves the combined effort (sequentially or simultaneously) of electrically powering barrier 12 downward and spring 40 moving barrier 12 backward via spring force 87.

Vehicle restraint 10 may include several additional features that enhance its operation or value. Barrier 12, for instance, has a raised edge 86 (FIG. 6) that leans back to help prevent the barrier from slipping off the truck's ICC bar.

Point 78, which couples the base of position cylinder 36 to frame 44, can be a pin and slot connection 88 that provides the base of cylinder 36 with limited sliding motion. The freedom to slide allows barrier 12 to respond more quickly to vertical movement of ICC bar 14 without always being dampened by the repeated extension and retraction of cylinder 36.

Referring to FIG. 1, vehicle restraint 10 may also include features that make the restraint easier to repair. Pin 68, for instance, fits within a slot 90 in bracket 70 where retaining bars 92 hold pin 68 in place. Similarly, at point 78, a pin 94 (e.g., a bolt) also fits within a slot 96. Thus, the working mechanism of restraint 10 can be easily lifted out from within frame 44 by unbolting pin 94 and removing retaining bars 92, which allows pins 68 and 94 to slide out from within their slots 90 and 96.

Restraint 10 can also be provided with a bar sensing device 98 that detects when barrier 12 is fully engaged with ICC bar 14. Such a sensing device can assume various forms, such as an upwardly biased lever 100 that a pin 102 pivotally connects to barrier 12. When barrier 12 engages the underside of ICC bar 14, the bar forces lever 100 downward relative to the upward moving barrier 12. A limit switch, proximity switch, magnet actuated sensor, etc., can be associated with lever 100 to generate a signal that indicates barrier-to-bar engagement. The signal can be used for various purposes including, but not limited to, triggering a light that tells operators in the area that the truck is restrained, initiating the depressurizing of main cylinder 34 so that barrier 12 retracts back against the forward facing surface of bar 14, and/or enabling dock leveler 24 to place its deck 26 and lip 28 upon the bed of truck 16.

Additional sensors, such as a limit switch, proximity switch, magnet actuated sensor, etc. can be installed at appropriate locations to sense other operating conditions or positions of vehicle restraint 10. A sensor, for example, could be used to indicate when barrier 12 is at its stored position of FIG. 3.

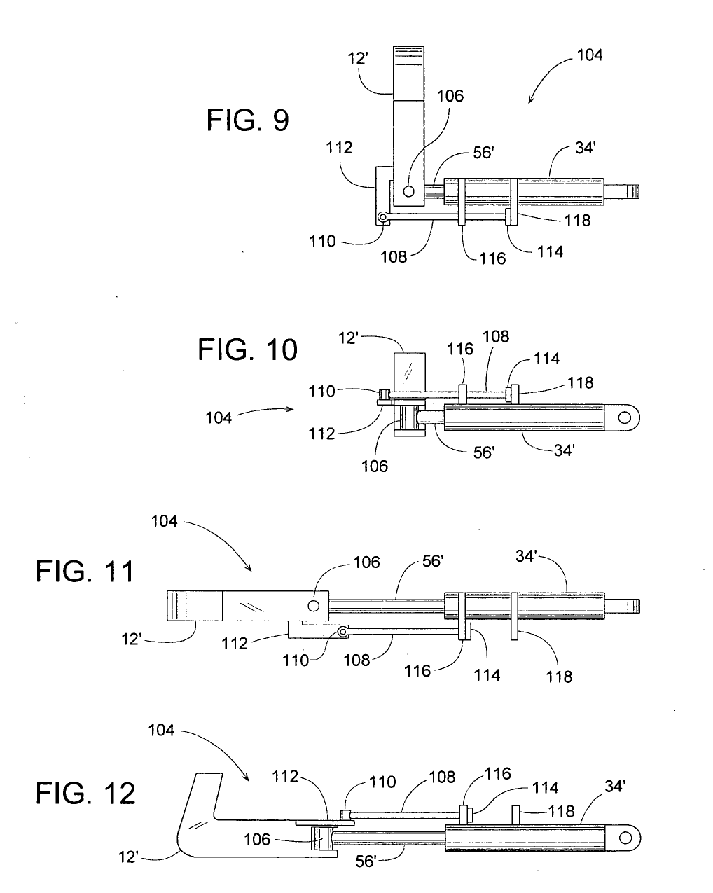

In some cases, it may be desirable to minimize the overall length of the restraint when in its stored position, thereby reducing the required size of sub-pit 32. To do this, barrier 12 and main cylinder 34 can be replaced by a mechanism 104 shown in FIGS. 9-12. FIGS. 9 and 10 respectively show a top and side view of mechanism 104 in its retracted, stored position, and FIGS. 11 and 12 respectively show a top and side view of mechanism 104 in its extended, operative position. As mechanism 104 retracts, a barrier 12′ flips back toward the face of the loading dock, assuming a generally right-angle position relative to its main cylinder 34′.

This is accomplished by having a pin 106 pivotally couple barrier 12′ to a piston rod 56′ of main cylinder 34′. A link 108 has one end 110 pivotally connected to a lug 112 extending from barrier 12′ and an opposite end terminating at a knob 114. Link 108 is free to slide within a guide member 116, but its sliding motion is limited by the distance that knob 114 can travel between guide member 116 and an end stop 118. When cylinder 34′ retracts to its stored position of FIGS. 9 and 10, knob 114 abuts end stop 118, which causes link 108 to push barrier 12′ around to its flipped back position. When cylinder 34′ extends to its operative position of FIGS. 11 and 12, knob 114 abuts guide member 116 so that link 108 pulls barrier 12′ around to its outreached position.

Although the invention is described with reference to a preferred embodiment, it should be appreciated by those of ordinary skill in the art that various modifications are well within the scope of the invention. For example, brush seals and/or other types of seals can be used to help cover the front opening of sub-pit 32. Uprights 120 of frame 44 may provide a suitable mounting surface to which such seals can be attached. Therefore, the scope of the invention is to be determined by reference to the following claims:

1. A vehicle restraint for engaging and limiting the forward movement of a vehicle's ICC bar away from a dock face that faces forward, the vehicle restraint, comprising:
a barrier being movable between a stored position and an operative position, wherein the barrier moves downward and backward to the stored position, and the barrier moves forward and upward to the operative position;
a spring system coupled to the barrier to urge the barrier upward and backward; and
a powered system coupled to the barrier to move the barrier selectively downward and forward, whereby movement of the barrier to the stored position is driven by a first combined effort from both the powered system and the spring system, and movement of the barrier to the operative position is driven by a second combined effort from both the powered system and the spring system.

2. The vehicle restraint of claim 1, wherein the barrier is movable to a range of resilient operative positions where the barrier can press upward and backward against the vehicle's ICC bar under the impetus of the spring system rather than under the impetus of the powered system, whereby the ICC bar is free to float within a certain allowable range of movement.

3. The vehicle restraint of claim 2, wherein the barrier is movable to a mechanically limited position that helps define the certain allowable range of movement.

4. The vehicle restraint of claim 3, wherein the powered system includes a main cylinder having a rod extension limit that helps determine the mechanically limited position of the barrier.

5. The vehicle restraint of claim 1, wherein the spring system includes a retract spring that urges the barrier backward and a position spring that urges the barrier upward.

6. The vehicle restraint of claim 1, wherein the powered system includes a main cylinder that can urge the barrier forward and a position cylinder that can urge the barrier downward.

7. The vehicle restraint of claim 6, wherein the main cylinder is installed so as to inhibit the main cylinder's ability to urge the barrier backward.

8. The vehicle restraint of claim 6, wherein the position cylinder is installed so as to inhibit the position cylinder's ability to urge the barrier upward.

9. The vehicle restraint of claim 1, further comprising a dock leveler, wherein the barrier in the stored position is disposed underneath the dock leveler.

10. A vehicle restraint for engaging and limiting the forward movement of a vehicle's ICC bar away from a dock face that faces forward, the vehicle restraint, comprising:
a frame mountable adjacent to the dock face;
a barrier coupled to the frame and being movable relative thereto between a stored position, a range of resilient operative positions, and a mechanically limited position, wherein the barrier is retracted backward and lowered in the stored position, the barrier is at least partially raised and partially extended forward while in the range of resilient operative positions, and the barrier is at least partially raised and fully extended forward in the mechanically limited position;
a spring system coupled to the barrier to urge the barrier upward and backward; and
a powered system coupled to the barrier so that the powered system can move the barrier downward and forward, whereby movement of the barrier to the stored position is driven by a first combined effort from both the powered system and the spring system, and movement of the barrier to the range of resilient operative positions is driven by a second combined effort from both the powered system and the spring system.

11. The vehicle restraint of claim 10, wherein the barrier in the range of resilient operative positions can press upward and backward against the vehicle's ICC bar under the impetus of the spring system rather than under the impetus of the powered system, whereby the ICC bar is free to float within a certain allowable range of movement.

12. The vehicle restraint of claim 1 1, wherein the mechanically limited position helps define the certain allowable range of movement.

13. The vehicle restraint of claim 10, wherein the powered system includes a main cylinder having a rod extension limit that helps determine the mechanically limited position of the barrier.

14. The vehicle restraint of claim 10, wherein the spring system includes a retract spring that urges the barrier backward and a position spring that urges the barrier upward.

15. The vehicle restraint of claim 10, wherein the powered system includes a main cylinder that can urge the barrier forward and a position cylinder that can urge the barrier downward.

16. The vehicle restraint of claim 15, wherein the main cylinder is installed so as to inhibit the main cylinder's ability to urge the barrier backward.

17. The vehicle restraint of claim 15, wherein the position cylinder is installed so as to inhibit the position cylinder's ability to urge the barrier upward.

18. The vehicle restraint of claim 10, further comprising a dock leveler, wherein the barrier in the stored position is disposed underneath the dock leveler.

19. A method of controlling a barrier of a vehicle restraint, wherein the barrier can limit the extent to which a vehicle's ICC bar can move forward away from a dock face, the method comprising:
electrically powering the barrier forward;
exerting spring force to move the barrier up against the vehicle's ICC bar;
exerting spring force to move the barrier back against the vehicle's ICC bar; and
using spring force to help the barrier follow both vertical and horizontal movement of the vehicle's ICC bar.

20. The method of claim 19, further comprising:
supporting the barrier by way of a hydraulic cylinder;
releasing fluid from within the hydraulic cylinder, thereby allowing the vehicle's ICC bar to move the barrier forward away from the dock face;
moving the vehicle's ICC bar forward away from the dock face to extend the hydraulic cylinder to a mechanical travel limit thereof; and
inhibiting further forward movement of the vehicle's ICC bar by virtue of the hydraulic cylinder reaching its mechanical travel limit.

21. The method of claim 19, further comprising hydraulically moving the barrier downward away from the vehicle's ICC bar.

22. The method of claim 19, further comprising storing the barrier at a position such that the dock face is farther forward than the barrier.

23. The method of claim 19, wherein the step of electrically powering the barrier forward involves hydraulically moving the barrier forward.
